(19) United States
(12) Patent Application Publication
(10) Pub. No.: US 2008/0056239 A1
(43) Pub. Date: Mar. 6, 2008

(54) VOIP Service Over a Regular Phone

(75) Inventor: Jean-Marc Loingtier, Atherton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Kalat Software, Inc., Belvedere, CA (US)

(21) Appl. No.: 11/777,922

(22) Filed: Jul. 13, 2007

Related U.S. Application Data
(60) Provisional application No. 60/831,183, filed on Jul. 13, 2006.

(51) Int. Cl. H04L 12/66

(52) U.S. Cl. 370/352

(57) ABSTRACT

A VoIP link is established between a caller device and a target device that is the target of the call of the caller device. The caller device does not include web access software or VoIP agent software. To establish the VoIP link, a message is sent from the caller device to a server, the message identifying a number associated with the target device. Next, the phone numbers associated with the caller and target devices are collected and send as a VoIP command to one or more VoIP providers. In response, the VoIP provider attempts to establish a first VoIP link to the caller device and a second VoIP link to the target device. If the attempt to establish the VoIP links to the caller and target devices is successful, the server bridges the two VoIP links to enable the caller to talk to the target.

### CROSS-REFERENCES TO RELATED APPLICATIONS

The present application claims benefit under 35 USC 119(e) of U.S. provisional Application No. 60/831,183, filed on Jul. 13, 2006, entitled “System For Benefiting From VoIP Services (Including P2P-Based Services) Through A Regular Phone,” the content of which is incorporated herein by reference in its entirety.

### BACKGROUND OF THE INVENTION

The present application relates to voice communication, and more particularly, to a method of establishing a voice communication link over a packet-switched telephony networks.

Telephony services over a packet-switched network conforming to existing protocols, such as Voice over the Internet Protocol (VoIP), are gaining wide acceptance. A packet-switched gateway is typically used to bridge a circuit switched network, such as the Public Switched Telephone Network (PSTN,) and a VoIP packet-switched network.

One method of establishing a voice connection between two users over a VoIP network is call-back, as shown in FIG. 1. In accordance with this method, caller 15 calls centralized VoIP service provider center 20, enters the phone number of party 25 that caller 15 seeks to reach, and subsequently terminates the call. Thereafter, centralized VoIP service provider center 20 calls both parties 15 and 25 to establish a VoIP connection between them. In a centralized VoIP system, the bandwidth capacity required to handle voice traffic during peak hours becomes partly idle during non-peak hours, thereby resulting in waste.

In accordance with another method, a VoIP link may be established between two parties by using a system of distributed personal computers, such as that developed by Skype™, as shown in FIG. 2. When a user of any one of the personal computers (nodes), such as node 35₁, seeks to establish a VoIP call to another node, such as node 35₂, one or more of the other nodes, such as nodes 35₃ and 35₄, depending on their availability, are used to from the required VoIP link. Nodes 35₁, 35₂, 35₃ . . . 35_{N} collectively form a network cloud 50. Compression and decompression (codec) functions, if required, are performed by the two calling nodes 35₁, and 35₂.

If a node in network cloud 50 is behind a firewall and is not directly accessible by an IP address, a server (not shown) mediates between the two intermediate nodes, e.g. nodes 35₃ and 35₄, to establish the required connection.

In one conventional technique, to enable a mobile phone user to benefit from distributed VoIP network systems, such as Skype™, the mobile phone is required to run a specialized VoIP software. Such VoIP software would enable the mobile phone to make VoIP calls in the same manner as a personal computer. Many users find the process of downloading software to their phones challenging and undesirable.

In accordance with another conventional technique, a mobile phone is provided with web access software. The user's personal computer establishes the VoIP link and calls back the mobile phone via the web access software. Accordingly, the mobile phone is required to be intelligent. A need continues to exist for mobile users to be able to conduct VoIP calls without the disadvantages mentioned above.

### BRIEF SUMMARY OF THE INVENTION

In accordance with one embodiment of the present invention, a Voice over Internet Protocol (VoIP) link is established between a first device (caller device) and a second device (target device) that is the target of the call of the caller device. The caller device does not include web access software or VoIP agent software. To establish the VoIP link, a message is sent from the caller device to a server, the message identifying a number associated with the target device. Next, the phone numbers associated with the caller and target devices are collected and sent as a VoIP command to one or more VoIP providers. In response, the VoIP provider(s) attempt to establish a first VoIP link to the caller device and a second VoIP link to the target device. If the attempt to establish the VoIP links to the caller and target devices is successful, the server bridges the two VoIP links to enable the caller to talk to its target. The message may be an Instant Message (IM), a Short Message Service (SMS) message, or Unstructured Supplementary Service Data (USSD) message.

In one embodiment, each of the caller and target devices includes a mobile phone. In another embodiment, the target device is a landline phone. In yet another embodiment, the target device is a personal computer. In one embodiment, the caller device is a landline phone. In one embodiment, the message is the number associated with the second device. In one embodiment, the attempt to establish the VoIP links is made via one or more centralized systems. In yet another embodiment, the attempt to establish the VoIP links is made via a distributed system, such as the distributed system developed by Skype™.

In one embodiment, the first and second VoIP links are provided by the same VoIP provider. In another embodiment, a first VoIP provider establishes the first VoIP link and a second VoIP provider establishes the second link. In one embodiment, a directory of names is displayed to the caller. In one embodiment, a list of names partially matching one or more alphanumeric characters disposed in the message is displayed to the user. In one embodiment, an inquiry is made to determine whether a user of the target device is available for a call with a user (caller) of the first device. In one embodiment, if the attempt to establish a VoIP call to the target device is detected as being unsuccessful, e.g., because the target device is detected as being busy, the caller is so notified.

In accordance with another embodiment of the present invention, a VoIP link is established between a first device (caller device) and a second device (target device) that is the target of the call of the caller device. The caller device does not include web access software or VoIP agent software. To establish the VoIP link, a message is sent from the caller device to a personal computer associated with a user of the caller device, the message identifying a number associated with the target device. Next, the phone numbers associated with the caller and target devices are collected by the personal computer and sent as a VoIP command to one or more VoIP providers. Using the two numbers, the VoIP provider(s) attempts to establish a first VoIP link to the caller device and a second VoIP link to the target device. If the attempt to establish the VoIP links to the caller and target devices is successful, the personal computer bridges the two VoIP links to enable the caller to talk to the target. The message may be an Instant Message (IM).

In one embodiment, each of the caller and target devices includes a mobile phone. In another embodiment, the target device is a landline phone. In yet another embodiment, the target device is a personal computer. In one embodiment, the caller device is a landline phone. In one embodiment, the message is the number associated with the second device. In one embodiment, the attempt to establish the VoIP links is made via one or more centralized systems. In yet another embodiment, the attempt to establish the VoIP links is via a distributed system, such as the distributed system developed by Skype.

In one embodiment, the first and second VoIP links are provided by the same VoIP provider. In another embodiment, a first VoIP provider establishes the first VoIP link and a second VoIP provider establishes the second link. In one embodiment, a directory of names is displayed to the caller. In one embodiment, a list of names partially matching one or more alphanumeric characters disposed in the message is displayed to the user. In one embodiment, an inquiry is made to determine whether a user of the target device is available for a call with a user (caller) of the first device. In one embodiment, if the attempt to establish a VoIP call to the target device is detected as being unsuccessful, e.g., because the target device is detected as being busy, the caller is so notified.

In accordance with yet another embodiment of the present invention, a VoIP link is established between a first device (caller device) and a second device (target device) that is the target of the call of the caller device. The caller device does not include web access software or VoIP agent software. To establish the VoIP link, a message is sent from the caller device to a server, the message identifying a number associated with the target device. Next, the phone numbers associated with the caller and target devices are collected by the server and are sent to a personal computer associated with a user of the caller device. The personal computer processes the information it receives and sends the two numbers as a VoIP command to one or more VoIP providers. Using the two numbers, the VoIP provider(s) attempts to establish a first VoIP link to the caller device and a second VoIP link to the target device. If the attempt to establish the VoIP links to the caller and target devices is successful, the personal computer bridges the two VoIP links to enable the caller to talk to the target. The message may be an SMS message or a dial-tone message.

In one embodiment, each of the caller and target devices includes a mobile phone. In another embodiment, the target device is a landline phone. In yet another embodiment, the target device is a personal computer. In one embodiment, the caller device is a landline phone. In one embodiment, the message is the number associated with the second device. In one embodiment, the attempt to establish the VoIP links is made via one or more centralized systems. In yet another embodiment, the attempt to establish the VoIP links is via a distributed system, such as the distributed system developed by Skype™, or any other soft phone residing on a personal computer thus enabling the personal computer to communicate via VoIP link.

In one embodiment, the first and second VoIP links are provided by the same VoIP provider. In another embodiment, a first VoIP provider establishes the first VoIP link and a second VoIP provider establishes the second link. In one embodiment, a directory of names is displayed to the caller. In one embodiment, a list of names partially matching one or more alphanumeric characters disposed in the message is displayed to the user. In one embodiment, an inquiry is made to determine whether a user of the target device is available for a call with a user (caller) of the first device. In one embodiment, if the attempt to establish a VoIP call to the target device is detected as being unsuccessful, e.g., because the target device is detected as being busy, the caller is so notified.

### BRIEF DESCRIPTION OF THE DRAWINGS

FIG. 1 is a simplified diagram of establishing a VoIP connection between two users using a centralized system, as known in the prior art.

FIG. 2 is a simplified diagram of establishing a VoIP connection between two users using a distributed system, as known in the prior art.

FIG. 3 shows various hardware/software modules as well as the flow of information/data therebetween so as to enable a VoIP connection between two devices, in accordance with one embodiment of the present invention.

FIG. 4 shows various hardware/software modules as well as the flow of information/data signals therebetween so as to enable a VoIP connection between two devices, in accordance with another embodiment of the present invention.

FIG. 5 shows various hardware/software modules as well as the flow of information/data signals therebetween so as to enable a VoIP connection between two devices, in accordance with another embodiment of the present invention.

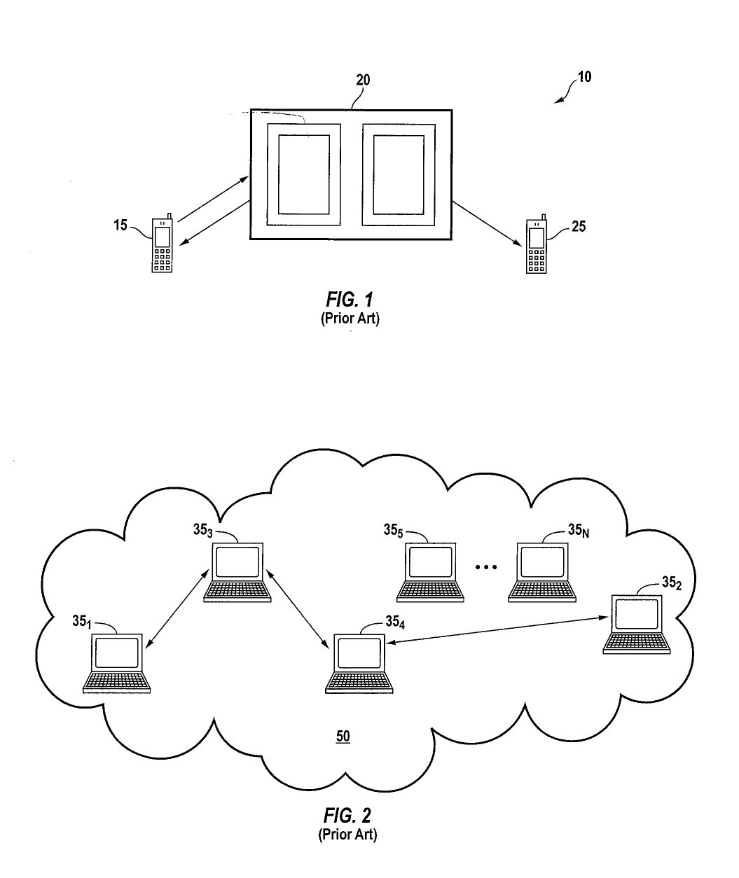

### DETAILED DESCRIPTION OF THE INVENTION

In accordance with one embodiment of the present invention, a device with telephony capability and equipped with instant messaging software may be used to conduct a Voice over Internet Protocol (VoIP) call. The device is not required to run VoIP or web access software. The messaging capability of the device is used to remotely control the VoIP telephony. The following description is provided with reference to establishing a VoIP connection between two devices adapted to engage in a voice communication. It is understood, however, that the present invention may also be used to establish a VoIP call between any number of devices. Furthermore, although the following description is made with reference to a mobile phone seeking to engage in a voice communication with another phone, it is understood that the present invention is equally applicable when the phone from which the initial call is made is a landline phone. Moreover, the phone that is the target of the call may be a mobile phone, a landline phone, a sot phone, i.e., a personal computer running software that allows the personal computer to communicate using one or more VoIP connection, etc.

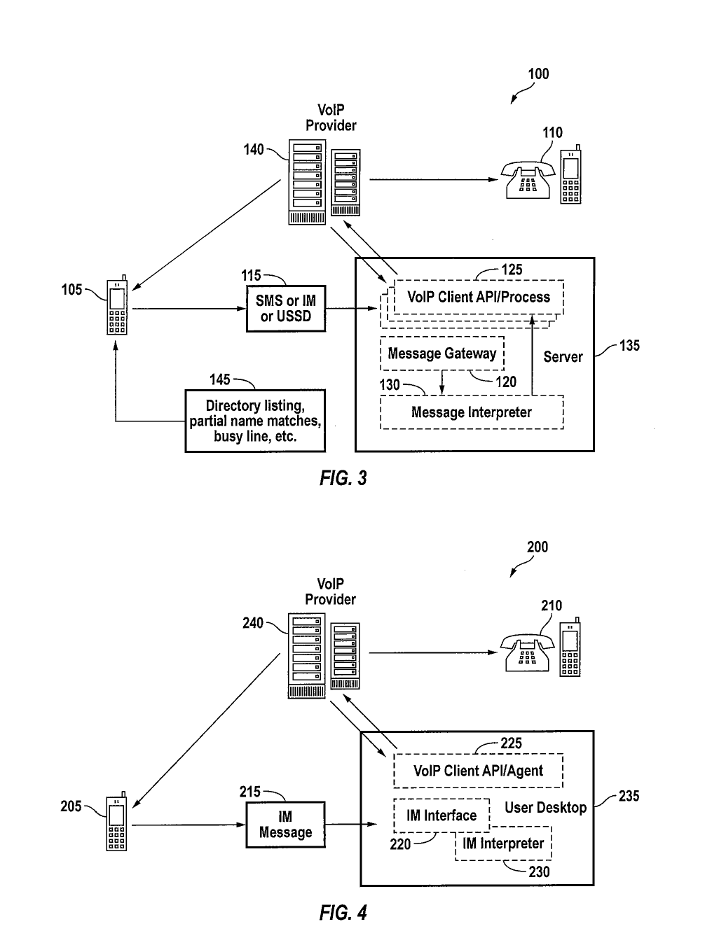

FIG. 3 shows various hardware/software modules as well as the flow of information/data signals between these modules that enable a VoIP connection to be made between caller device 105 and called device 110, in accordance with one embodiment of the present invention. Hereinbelow devices 105 and 110 are referred to as phones, although it is understood that devices 105 and 110 may be any type of devices, mobile or landline, with telephony capability. For example, device 110 may be a personal computer.

To establish a VoIP call from phone 105 to phone 110, the user of phone 105 transmits a short message 115 identifying the calling number of phone 110. This message may conform to the Instant Messaging (IM) standard, the Short Message Service (SMS) standard, an Unstructured Supplementary Service Data (USSD) standard, etc. Message 115 is received by message gateway 120. It is understood that if message 115 is an IM message, it is received by an IM message gateway. Similarly, if message 115 is an SMS message, it is received respectively by an SMS message gateway; if message 115 is a USSD message, it is received by a USSD message gateway. Message gateway 120, message interpreter 125 and VoIP client API/Process module 125 are disposed in server 135.

Message interpreter 130 receives the message from message gateway 120 and uses this message to provide the phone numbers of phones 105 and 110 to VoIP client Application Programming Interface (API)/Process module 125. In response, VoIP client API/Process module 125 asks one or more VoIP providers 140 to provide the termination points of the calls by calling phones 105 and 110. After the calls to phones 105 and 110 is established, server 135 bridges the VoIP connections made to phones 105 and 110, to enable the users of these two phones to talk to one another. For example, VoIP client API/Process module 125 may ask a first VoIP provider to provide a link to phone 110, and a second VoIP provider to provide a link to phone 105. The links established by the first and second VoIP providers is subsequently bridged by server 135. In another embodiment, the same VoIP provider is used to provide the links to both phones 105 and 110. The callback can be carried out using IM, SMS, USSD or dial tones.

In one embodiment, when message 115 transmitted by phone 105 is a SMS or USSD message, a message 145 may be transmitted back to phone 105 to provide information such as directory listing, partial matches on names that phone 105 has identified, as well as whether, for example, the line to phone 110 is busy. For example, suppose the caller sends the message: “+16505551212 AB”. Subsequently, two outgoing VoIP calls are established, one to the phone number of the caller (using the caller ID), and another one using the number “+16505551212”. All subsequent messages to “AB” will result into an outgoing calls to the number “+16505551212”. Accordingly, a directory of names/numbers is created on the fly.

In one embodiment, when VoIP provider(s) 140 also provides messaging services, such as IM, SMS or USSD messages, VoIP provider(s) 140 can send messages to the user of phone 110, such as “are you available to talk now?” The answer to such messages is subsequently reported to the user of phone 105.

In one embodiment, phone 105 may operate in one of two modes, namely a regular mode and a VoIP mode. When selected by the user to operate in the VoIP mode, the caller enters the phone number of the party the caller is trying to reach. In response, a message is transmitted to message gateway 120 to begin the process of establishing the VoIP link between the two parties, as described above. Accordingly, in such embodiments, the caller experiences nearly a regular call experience. In one embodiment, the message that triggers the callback may be sent in response to the caller scrolling up/down the list of names and contacts stored in the phone 105's directory and selecting the target of the call from this list, i.e., the person/number the caller seeks to call.

When a distributed peer-to-peer, P2P, system, such as Skype™ is used, VoIP client API/Process module 125 also provides the termination calls to phones 105 and 110, thereby dispensing the need for use of VoIP Provider 140. Accordingly, in such embodiments, the mobile phone seeking to place a VoIP call is used to remotely control a Skype™ client.

FIG. 4 shows various hardware/software modules as well as the flow of information/data signals between these modules that enable a VoIP connection to be made between a caller device 205 and a called device 210, in accordance with another embodiment of the present invention. Hereinbelow devices 205 and 210 are referred to as phones, although it is understood that devices 205 and 210 may be any type of devices, mobile or landline, with telephony capability. Furthermore, device 210 may be a personal computer.

To establish a VoIP call from phone 205 to phone 210, the user of phone 205 transmits an IM message 215 to an associated personal computer 235. Message 215 is received via IM interface 220 disposed in computer 235. IM interpreter 230 receives the message from IM interface 230 and uses this message to provide the phone numbers of phones 205 and 210 to VoIP client API/Process module 225. In response, VoIP client API/Process module 225 asks one or more VoIP providers 240 to provide the termination points of the calls by calling phones 205 and 210. A soft switch running on personal computer 235 and disposed in VoIP client API/Agent module 225 subsequently bridges the VoIP connections made to phones 205 and 210, to enable the users of these two phones to talk to one another. For example, VoIP client API/Process module 225 may ask a first VoIP provider to provide a link to phone 210, and a second VoIP provider to provide a link to phone 205. The links established by the first and second VoIP providers is subsequently bridged by a soft switch running on computer 235. In another embodiment, the same VoIP provider is used to provide the VoIP links to both phones 205 and 210.

In embodiments where a personal computer associated with the caller is used to bridge the outgoing VoIP calls to the two devices, such as the embodiment shown in FIG. 4, the message triggering the callback can be carried out using IM, SMS, USSD or dial tones. Consequently, in accordance with the present invention, mobile phone 205 remotely controls the soft switch running on personal computer 235 to bridge the call that enable the user of phones 205 and 210 to talk to one another.

In one embodiment, phone 205 may operate in one of two modes, namely a regular mode and a VoIP mode. When selected to operate in the VoIP mode, the caller enters the phone number of the party the caller is trying to reach. In response, a message is transmitted to IM interface 220 to begin the process of establishing the VoIP link between the two parties as described above. Accordingly, in such embodiment, the caller experiences what is nearly a regular call experience.

When a distributed peer-to-peer system, such as Skype™ is used, VoIP client API/Process module 225 also provides the termination calls to phones 205 and 210, thereby dispensing the need for use of VoIP Providers 240. In such embodiments, a soft phone is resident in VoIP client API/Process module 225 to bridge the termination calls to enable phones 205 and 210 to connect to one another. In some embodiments, personal computer 235 is not a member of a peer-to-peer system. However, in such embodiments, personal computer 235 includes a soft phone that enables personal computer 235 to provide the termination calls to devices 205, 210, and further to bridge the termination calls to enable phones 205 and 210 to connect to one another. The soft phone in such embodiments is resident in VoIP client API/Process module 225.

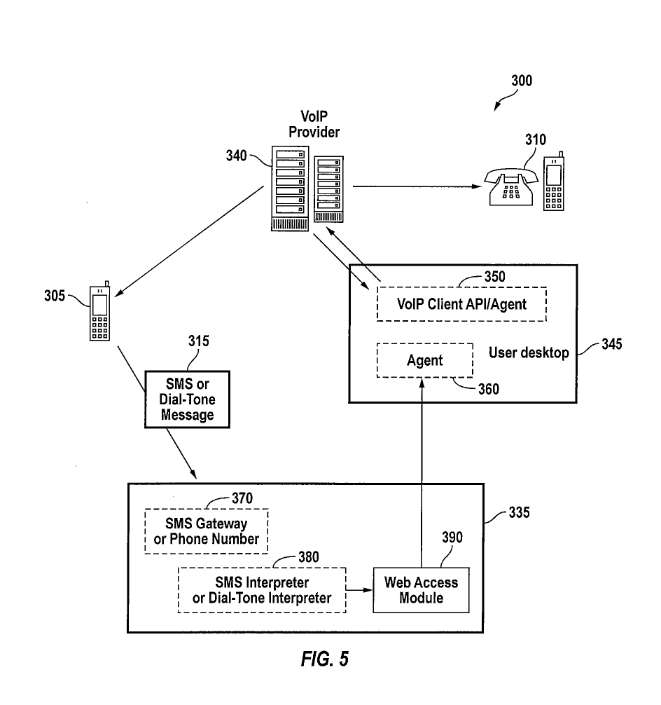

FIG. 5 shows various hardware/software modules as well as the flow of information/data signals between these modules that enable a VoIP connection to be made between caller device 305 and called device 310, in accordance with another embodiment of the present invention. Hereinbelow devices 305 and 310 are referred to as phones, although it is understood that devices 305 and 310 may be any type of devices, mobile or landline, with telephony capability. For example, device 310 may be a personal computer.

To establish a VoIP call from phone 305 to phone 310, the user of phone 305 transmits a message 315 identifying the calling number of phone 310. Message 315 may be an SMS message, or a dial-tone (DTMF) message. Message 315 is received by gateway 370 of server 335. If message 315 is an SMS message, it is received by an SMS message gateway. Similarly, if message 315 is a dial-tone message, it is received by a dial-tone message gateway.

Message interpreter 380 receives the message from message gateway 370 and uses this message to identify and interpret the phone numbers of phones 305 and 310. The numbers so identified are sent by web access module 390 of server 335 to software agent 360 running on computer 345 associated with the user of phone 305. Software agent 360, in turn, supplies the phone numbers of phones 305 and 310 to VoIP client API/Process module 350 also running on computer 335. In response, VoIP client API/Process module 350 sends a VoIP command asking one or more VoIP providers 340 to provide the termination points of the calls by calling phones 305 and 310. Computer 335 subsequently bridges the VoIP connections made to phones 305 and 310 by VoIP provider 340 so as to enable the users of these two phones to talk to one another. In one embodiment, a first VoIP provider may be asked to provide a link to phone 310, and a second VoIP provider may be asked to provide a link to phone 305. In another embodiment, the same VoIP provider is used to provide the links to both phones 305 and 310.

In one embodiment, a message (not shown) may be transmitted back to phone 305 to provide information such as directory listing, partial matches on names that phone 305 has identified, as well as whether, for example, the line to phone 310 is busy. In one embodiment, VoIP provider(s) 340 also provides SMS messaging services, and can send messages, such as “are you available to talk now?”, to the user of phone 310. The answer to such messages is subsequently reported to the user of phone 305.

In one embodiment, phone 305 may operate in one of two modes, namely a regular mode and a VoIP mode. When selected to operate in the VoIP mode, the caller enters the phone number of the party the caller is trying to reach. In response, a message is transmitted to message gateway 370 to begin the process of establishing the VoIP link between the two parties as described above. Accordingly, in such embodiment, the caller experiences what is nearly a regular call experience.

When a distributed pear-to-pear system, such as Skype™ is used, VoIP client API/Process module 350 also provides the termination calls to phones 305 and 310, thereby dispensing the need for use of VoIP Provider(s) 340.

The above embodiments of the present invention are illustrative and not limiting. Various alternatives and equivalents are possible. The invention is not limited by the number of users that may be connected during any given call. The invention is not limited by the type of message sent by the caller. Nor is the invention limited to the type of mobile phone the caller has. Other additions, subtractions or modifications are obvious in view of the present disclosure and are intended to fall within the scope of the appended claims.

What is claimed is:

1. A method of establishing a Voice over Internet Protocol (VoIP) link between a first device and a second device, said first and second devices being adapted to engage in a voice communication, said first device not to include web access software or VoIP agent software, the method comprising:
sending a message from the first device to a server, said message identifying a number associated with the second device;
transmitting a number associated with the first device and the number associated with the second device;
attempting to establish a first VoIP link to the first device and a second VoIP link to the second device in response to the transmitted first and second numbers; and
bridging the first and second VoIP links if the attempt is successful.

2. The method of claim 1 wherein said message is selected from a group consisting of Instant Message (IM), Short Message Service (SMS) message, or Unstructured Supplementary Service Data (USSD) message.

3. The method of claim 2 wherein each of said first and second devices includes a mobile phone.

4. The method of claim 2 wherein said second device is a landline phone.

5. The method of claim 2 wherein said first device is a landline phone.

6. The method of claim 2 wherein said message is the number associated with the second device.

7. The method of claim 2 further comprising:
establishing the first VoIP link via a first VoIP provider; and
establishing the second VoIP link via a second VoIP provider.

8. The method of claim 2 wherein said attempt is made via one or more centralized systems.

9. The method of claim 2 wherein said attempt is made via a distributed system.

10. A server system adapted to bridge a Voice over Internet Protocol (VoIP) link between a first device and a second device, said first and second devices being adapted to engage in voice communication, said first device not to include web access software or VoIP agent software, the server system comprising:
a gateway adapted to receive a message from the first device, said message identifying a number associated with the second device;
an interpreter adapted to identify the number associated with the second device and a number associated with the first device; and
a bridge adapted to bridge VoIP links established to first and second devices.

11. The server system of claim 10 wherein said gateway is selected from a group consisting of Instant Message (IM) gateway, Short Message Service (SMS) gateway, and Unstructured Supplementary Service Data (USSD) gateway.

12. The server system of claim 11 wherein each of said first and second devices includes a mobile phone.

13. The server system of claim 11 wherein said second device is a landline phone.

14. The server system of claim 11 wherein said first device is a landline phone.

15. The server system of claim 11 wherein said message is the number associated with the second device.

16. The server system of claim 11 wherein said bridge is adapted to bridge first and second VoIP links wherein said first link is established by a first VoIP provider and said second link is established by a second VoIP provider.

17. The server system of claim 11 wherein said bridge is adapted to bridge the VoIP links established via one or more centralized systems.

18. The server system of claim 11 wherein said bridge is adapted to bridge the VoIP links established via a distributed system.

19. A method of establishing a Voice over Internet Protocol (VoIP) link between a first device and a second device, said first and second devices being adapted to engage in a voice communication, said first device not to include web access software or VoIP agent software, the method comprising:
sending a message from the first device to a computer associated with a user of the first device, said message identifying a number associated with the second device;
transmitting a number associated with the first device and the number associated with the second device;
attempting to establish a first VoIP link to the first device and a second VoIP link to the second device in response to the transmitted first and second numbers; and
bridging the first and second VoIP links if the attempt is successful.

20. The method of claim 19 wherein said message is an Instant Message (IM).

21. The method of claim 20 wherein each of said first and second devices includes a mobile phone.

22. The method of claim 20 wherein said second device is a landline phone.

23. The method of claim 20 wherein said first device is a landline phone.

24. The method of claim 20 wherein said IM message is the number associated with the second device.

25. The method of claim 20 wherein comprising:
establishing the first VoIP link via a first VoIP provider; and
establishing the second VoIP link via a second VoIP provider.

26. The method of claim 20 wherein said attempt is made via one or more centralized systems.

27. The method of claim 20 wherein said attempt is made via a distributed system.

28. A personal computer system adapted to bridge a Voice over Internet Protocol (VoIP) link between a first device and a second device, said first and second devices being adapted to engage in voice communication, said first device not to include web access software or VoIP agent software, the personal computer system comprising:
a messaging interface adapted to receive a message from the first device, said message identifying a number associated with the second device;
an interpreter adapted to interpret the message and identify the number associated with the second device and a number associated with the first device; and
a VoIP agent adapted to bridge VoIP links established to first and second devices in response to a control command issued by the interpreter.

29. The personal computer system of claim 28 wherein said message is selected an Instant Message (IM).

30. The personal computer system of claim 29 wherein each of said first and second devices includes a mobile phone.

31. The personal computer system of claim 29 wherein said second device is a landline phone.

32. The personal computer system of claim 29 wherein said first device is a landline phone.

33. The personal computer system of claim 29 wherein said message is the number associated with the second device.

34. The personal computer system of claim 29 wherein said VoIP agent software is adapted to bridge first and second VoIP links wherein said first link is established by a first VoIP provider and said second link is established by a second VoIP provider.

35. The personal computer system of claim 29 wherein said VoIP agent is adapted to bridge the VoIP links established via one or more centralized systems.

36. The personal computer system of claim 29 wherein said VoIP agent is adapted to bridge the VoIP links established via a distributed system.

37. A method of establishing a Voice over Internet Protocol (VoIP) link between a first device and a second device, said first and second devices being adapted to engage in a voice communication, said first device not to include web access software or VoIP agent software, the method comprising:
sending a message from the first device to a server, said message identifying a number associated with the second device;
transmitting a number associated with the first device and the number associated with the second device to a computer system associated with a user of the first device;
attempting to establish a first VoIP link to the first device and a second VoIP link to the second device in response to the transmitted first and second numbers; and
bridging the first and second VoIP links via the computer system if the attempt is successful.

38. The method of claim 37 wherein said message is selected from a group consisting of Short Message Service (SMS) message, Unstructured Supplementary Service Data (USSD) message, and dial-tone message.

39. The method of claim 38 wherein each of said first and second devices includes a mobile phone.

40. The method of claim 38 wherein said second device is a landline phone.

41. The method of claim 38 wherein said first device is a landline phone.

42. The method of claim 38 wherein said message is the number associated with the second device.

43. The method of claim 38 further comprising:
establishing the first VoIP link via a first VoIP provider; and
establishing the second VoIP link via a second VoIP provider.

44. The method of claim 38 wherein said attempt is made via one or more centralized systems.

45. The method of claim 38 wherein said attempt is made via a distributed system.

46. A system adapted to bridge a Voice over Internet Protocol (VoIP) link between a first device and a second device, said first and second devices being adapted to engage in voice communication, said first device not to include web access software or VoIP agent software, the system comprising a server, said server comprising:
a gateway adapted to receive a message from the first device, said message identifying a number associated with the second device;
an interpreter adapted to identify the number associated with the second device and a number associated with the first device; and
a module adapted to transmit the numbers associated with the first and second devices to a personal computer associated with a user of the first device.

47. The system of claim 46 wherein said gateway is selected from a group consisting of Short Message Service (SMS) gateway, Unstructured Supplementary Service Data (USSD) gateway, and dial-tone gateway.

48. The system of claim 47 wherein each of said first and second devices includes a mobile phone.

49. The system of claim 47 wherein said second device is a landline phone.

50. The system of claim 47 wherein said first device is a landline phone.

51. The system of claim 47 wherein said message is the number associated with the second device.

52. The system of claim 47 wherein said bridge is adapted to bridge first and second VoIP links wherein said first link is established by a first VoIP provider and said second link is established by a second VoIP provider.

53. The system of claim 47 wherein said personal computer further comprises:
a VoIP agent adapted to bridge VoIP links established to first and second devices, said VoIP links established via one or more centralized systems.

54. The system of claim 47 wherein said computer system further comprises:
a VoIP agent adapted to bridge VoIP links established to first and second devices, said VoIP links established via a distributed system.
